(19) United States
(12) Patent Application Publication
(10) Pub. No.: US 2009/0114587 A1
(43) Pub. Date: May 7, 2009

(54) NEGATIVE PRESSURE REVERSE OSMOSIS FILTERING MEMBRANE SYSTEM

(75) Inventor: Chi-Chang Kuo, Taichung (TW)

Correspondence Address: PAI PATENT & TRADEMARK LAW FIRM, 1001 FOURTH AVENUE, SUITE 3200, SEATTLE, WA, 98154, US

(73) Assignee: NEW CENTURY MEMBRANE CO., LTD, Taichung (TW)

(21) Appl. No.: 11/934,779

(22) Filed: Nov. 4, 2007

(51) Int. Cl. B01D 25/12

(52) U.S. Cl. 210/346

(57) ABSTRACT

A negative pressure reverse osmosis filtering membrane system includes multiple reverse osmosis filtering members, multiple buckle units, multiple sealing members, a first base and a second base. Each of the reverse osmosis filtering members includes a supporting plate, a first membrane, a second membrane, and an aperture. The first membrane and the second membrane sandwiches the supporting plate to define a room. The aperture is defined along an axis and through the supporting plate, the first membrane and the second membrane to communicate with the room. The buckle units are embedded next to each other and alternately stacked with the reverse osmosis filtering members. The sealing members are respectively clamped between the buckle unit and the reverse osmosis filtering member. The first base further includes a pump hole communicating with the aperture and pumping the filtered liquid out of the reverse osmosis filtering membrane system by a negative pressure.

### BACKGROUND

1. Field of Invention

The present invention relates to a water treatment system, and more particularly to a low power negative pressure reverse osmosis filtering membrane system with convenient membrane purge, and less possibility of concentration polarization.

2. Description of Related Art

Refer to FIG. 1. The water filtering system 100 substantially includes multiple filtering units 130 and multiple membrane spacers 160 clamped between adjacent filtering units 130 to provide a sewage channel communicating with each filtering unit 130, as known as a flat-sheet water filtering system 100. Each of the filtering units 130 has two membranes 110 (RO membrane or UF membrane) and a membrane support plate 120 clamped between the membranes 110 to be capable of containing liquid. The filtering units 130 respectively have an exhaust 131 for connecting with tubes 140, and an opening 132 defined in the center of the membrane 110 to receive and hold an axial column 150. In addition, the water filtering system 100 further includes an upper cover 170 and a base 180 whereby the filtering units 130 and the membrane spacers 160 are held between the upper cover 170 and the base 180 to prevent the water filtering system 100 from leaking. The base 180 has an inlet 181, and the upper cover 170 has an outlet 171 wherein the inlet 181 and the outlet 171 are defined on opposite ends of the sewage channel.

Consequently, the sewage is pumped into the sewage channel from the inlet 181, and flows through the filtering units 130 to be filtered. The filtered liquid is collected through the conductance of the exhausts 131, and the concentrated sewage is drained from the outlet 171.

However, the conventional water filtering system 100 has the following problems:

1. High operating pressure is needed to increase large amount of filtered liquid. The operating pressure of the conventional water filtering system 100 should be kept between 15-30 kgw/cm² to maintain the predetermined amount of filtered liquid. However, high operating pressures are high power consumption, and may result in water leakage because no other sealing devices are designed to prevent this problem except the upper cover 170 and the base 180.

2. The sewage is filtered layer by layer but not diffusion filtered by cross flow method such that the filtering speed is slowed down gradually and the concentration polarization effect easily occurs and causes deposited mud adhesion problems.

3. The stacked membranes are fastened inside the conventional water filtering system 100, and are not easily cleaned from the outside. The entire system must be demounted so that a purge method can be processed to clean. Nevertheless, additional cost consumption arises because the system is shut down.

### SUMMARY

It is therefore an aspect to provide a negative pressure reverse osmosis filtering membrane system capable of being immersed into a sewage tank without a case. Compared with the conventional flat-sheet water filtering system, the negative pressure reverse osmosis filtering membrane system in accordance with the present invention can be directly purged by flushing or scraping the deposit on the membrane surface, and the entire system does not need to be shut down to demount for cleaning purpose.

It is therefore another aspect to provide a negative pressure reverse osmosis filtering membrane system with a lower operating pressure to enhance the water tightness effect, and reduce the water leakage problem and sewage osmosis problem.

It is therefore another aspect to provide a negative pressure reverse osmosis filtering membrane system wherein the cross flow provides a shear stress on the membrane surface to prevent the mud from adhering to the membrane surface. Besides, the open sewage tank decreases concentration polarization, and extends the membranes life.

In accordance with an embodiment of the present invention, the negative pressure reverse osmosis filtering membrane system includes a plurality of reverse osmosis filtering members, a plurality of buckle units, a plurality of sealing members, a first base and a second base.

Each of the reverse osmosis filtering members comprises a supporting plate, a first membrane, a second membrane, and an aperture. The first membrane and the second membrane sandwiches the supporting plate to define a room. The aperture is defined along an axis through the supporting plate, the first membrane and the second membrane to communicate with the room.

The buckle units are embedded next to each other and alternately stacked with the reverse osmosis filtering members. Each of the buckle units includes two conducting discs embedded with each other and sandwiching one reverse osmosis filtering member. The conducting discs respectively include an opening, multiple embedded fingers, and multiple lock portions. The opening is coaxial to and communicated with the aperture of the reverse osmosis filtering member. In each buckle unit, the embedded fingers of the lower conducting disc are set through the aperture and adjacent to the first membrane, and the lock portions of the lower conducting disc are adjacent to the second membrane. The embedded fingers of the lower conducting disc are fixed within the lock portions of the upper conducting disc to provide a firm orientation, and the embedded fingers of the lower conducting disc are disengaged from the lock portions of the upper conducting disc to provide a looser orientation.

The sealing members are respectively clamped between the conducting disc and each of the reverse osmosis filtering members. The first base is mounted to the topmost reverse osmosis filtering member. The first base further includes a pump hole communicating with the aperture and pumping the filtered liquid out of the reverse osmosis filtering membrane system by a negative pressure. The second base is mounted to the bottom reverse osmosis filtering member.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a schematic view of a conventional flat-sheet water filtering system;

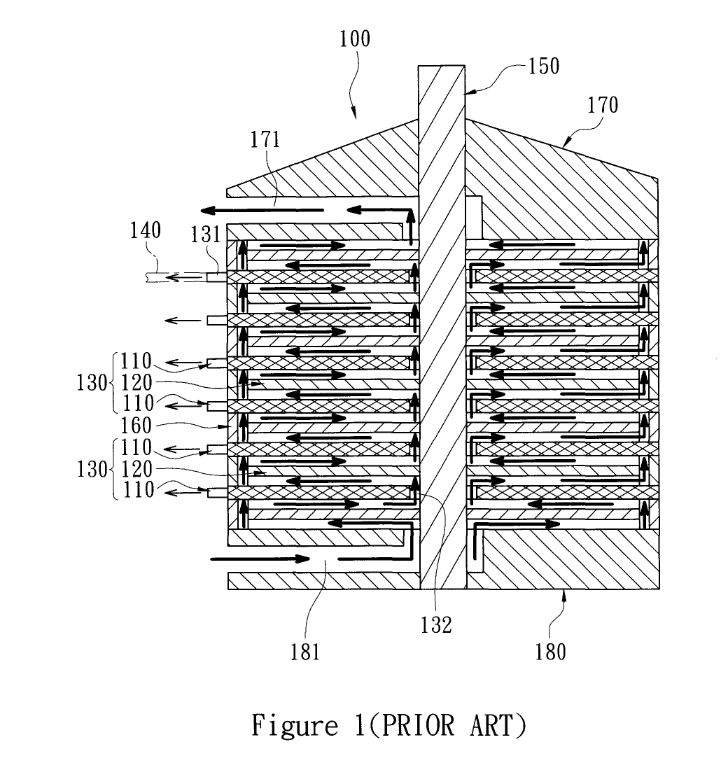

FIG. 2 is an exploded view of a reverse osmosis filtering member and a buckle unit of the first embodiment of a negative pressure reverse osmosis filtering membrane system in accordance with the present invention;

FIG. 3 is a partial perspective view of a supporting plate of the reverse osmosis filtering member;

FIG. 4 is a sectional view of the assembly between the reverse osmosis filtering member and the buckle unit;

FIG. 5 is perspective view of a conducting disc of the buckle unit;

FIG. 6 is a partial perspective view in accordance with FIG. 4;

FIG. 7 is a partial enlarged view showing the embedment between an embedded finger and a lock portion of the adjacent conducting discs;

FIG. 8 is a sectional view of the first embodiment of a negative pressure reverse osmosis filtering membrane system immersed into a sewage tank 910; and

FIG. 9 is a sectional view of another embodiment of a negative pressure reverse osmosis filtering membrane system in accordance with the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

While the specification concludes with claims defining the features of the invention that are regarded as novel, it is believed that the invention will be better understood from a consideration of the following description in conjunction with the figures, in which like reference numerals are carried forward.

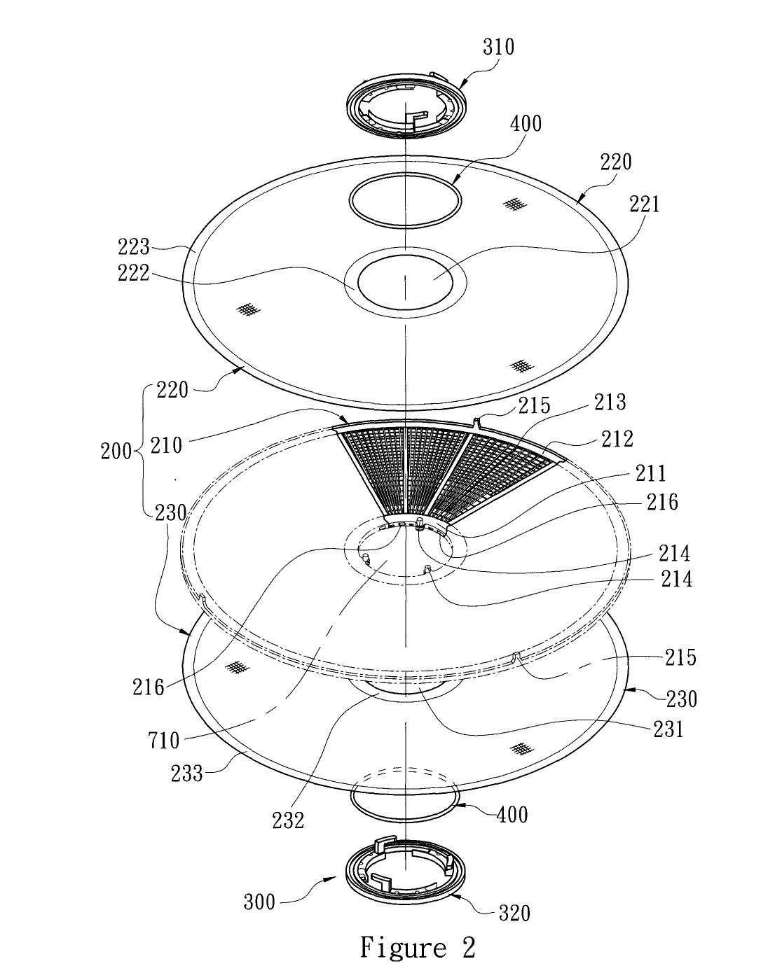

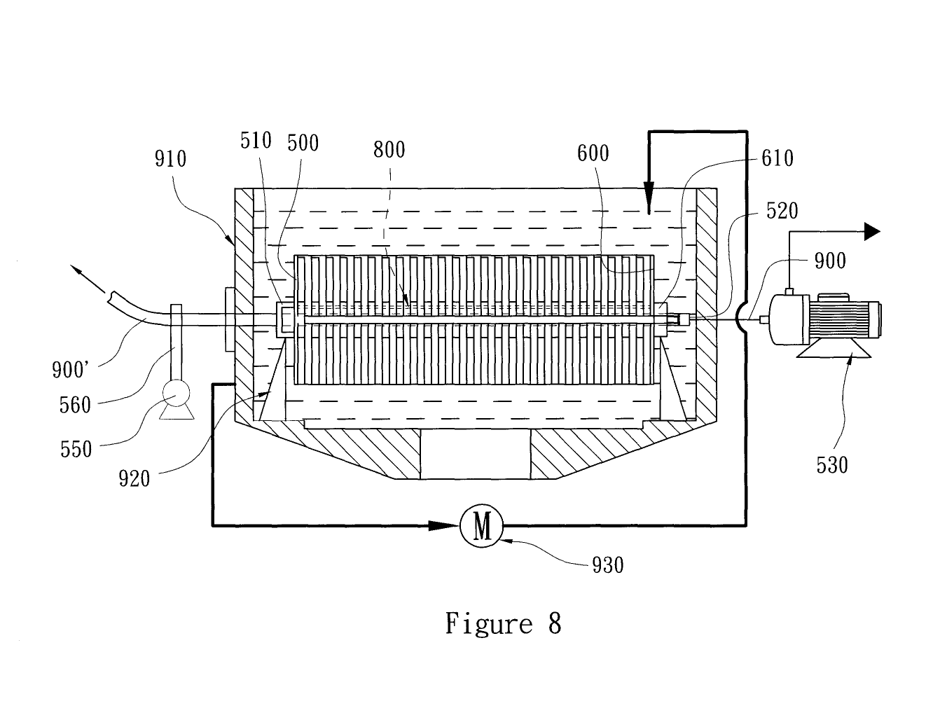

Refer to FIG. 2 and FIG. 8. The negative pressure reverse osmosis filtering membrane system includes a plurality of reverse osmosis filtering members 200, a plurality of buckle units 300, a plurality of sealing members 400, a first base 500 and a second base 600.

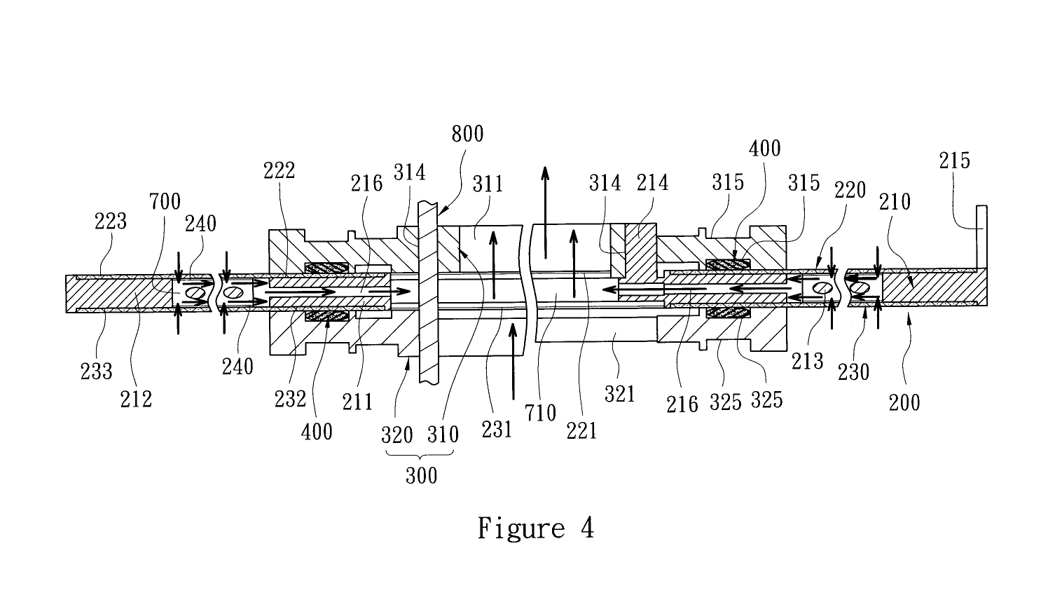

Refer to FIG. 2 and FIG. 4. Each of the reverse osmosis filtering members 200 includes a supporting plate 210, a first membrane 220 a second membrane 230 and an aperture 710. The first membrane 220 and the second membrane 230 sandwich the supporting plate 210 to define a room 700, and the aperture 710 is defined along an axis and through the supporting plate 210, the first membrane 220 and the second membrane 230 to communicate with the room 700.

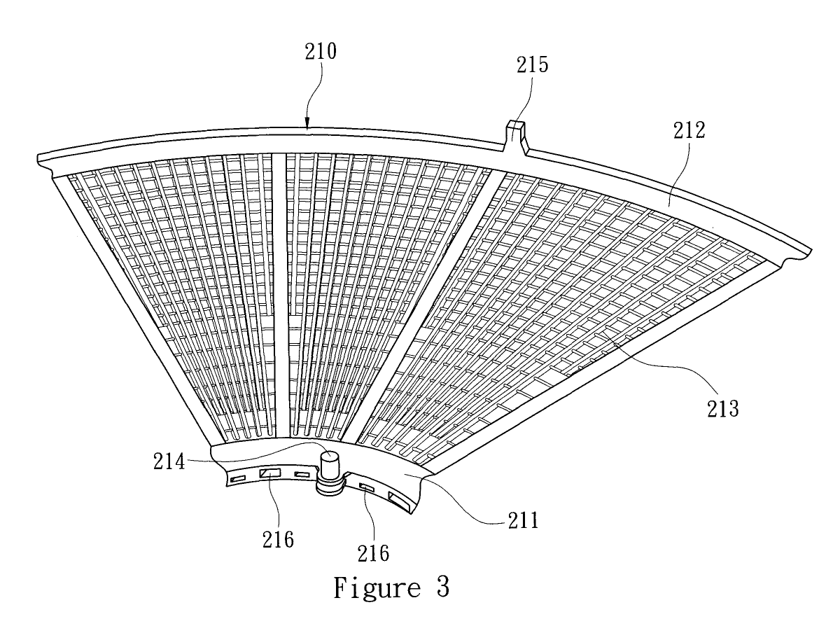

Refer to FIG. 2, FIG. 3 and FIG. 4. The supporting plate 210 has an inner ring 211, an outer ring 212, a net 213, multiple protrusions 214, multiple blocks 215, and multiple passages 216. The outer ring 212 is concentric to the inner ring 211, and the net 213 is connected between the inner ring 211 and the outer ring 212. The protrusions 214 protrude outward from the inner ring 211, and the blocks 215 protrude outward from the outer ring 212. The passages 216 are arranged radially on the inner ring 211 and are perpendicular to the aperture 710 to communicate with the aperture 710 and the room 700.

Refer to FIG. 2 and FIG. 4. The first membrane 220 and the second membrane 230 are reverse osmosis membranes, and the nano-filtration membranes with lower operation pressure are included to embody the first membrane 220 and the second membrane 230. In addition, hydrophilic materials of —OH group and —SO₃H group are added on the surface of the membranes to provide the membranes with hydrophile effects and reduce the adhesion problem of mud or particle suspension. The first membrane 220 and the second membrane 230 respectively have a first central hole 221 and a second central hole 231, a first inner circle 222 and a second inner circle 232, and a first outer circle 223 and a second outer circle 233. The first membrane 220 is tightly attached on one surface of the supporting plate 210 through the bonds between the inner ring 211 and the first inner circle 222, and the outer ring 212 and the first outer circle 223 to provide a space 240 between the first membrane 220 and the supporting plate 210. The second membrane 230 is tightly attached on the other surface of the supporting plate 210 through the bonds between the inner ring 211 and the second inner circle 232, and the outer ring 212 and the second outer circle 233 to provide another space 240 between the second membrane 230 and the supporting plate 210. The spaces 240 communicate with the room 700 of the supporting plate 210.

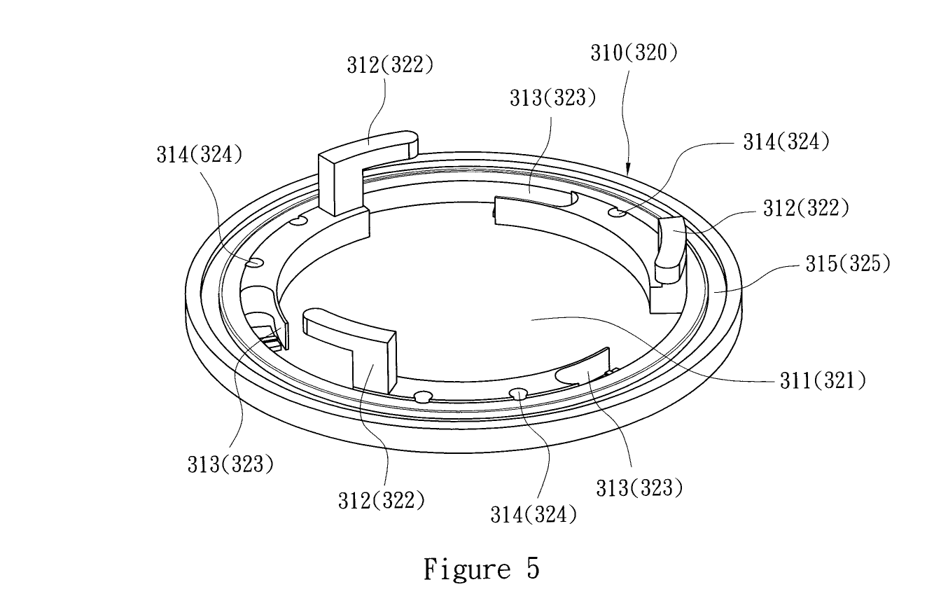

Refer to FIG. 2, FIG. 4 and FIG. 5. The buckle units 300 are embedded next to each other and are alternately stacked with the reverse osmosis filtering members 200. Each of the buckle units 300 comprises two conducting discs 310 and 320 embedded with each other and sandwiches the reverse osmosis filtering member 200. The conducting discs 310 and 320 respectively include an opening 311 and 321, multiple embedded fingers 312 and 322, multiple lock portions 313 and 323, multiple bores 314 and 324, and two grooves 315 and 325. The opening 311 and 321 are coaxial to and communicate with the aperture 710. The bores 314 and 324 correspond to and hold the protrusions 214 of the supporting plate 210. The grooves 315 and 325 are respectively defined on opposite surfaces of the conducting discs 310 and 320, and around the embedded fingers 312 and 322, the lock portions 313 and 323, and the bores 314 and 324.

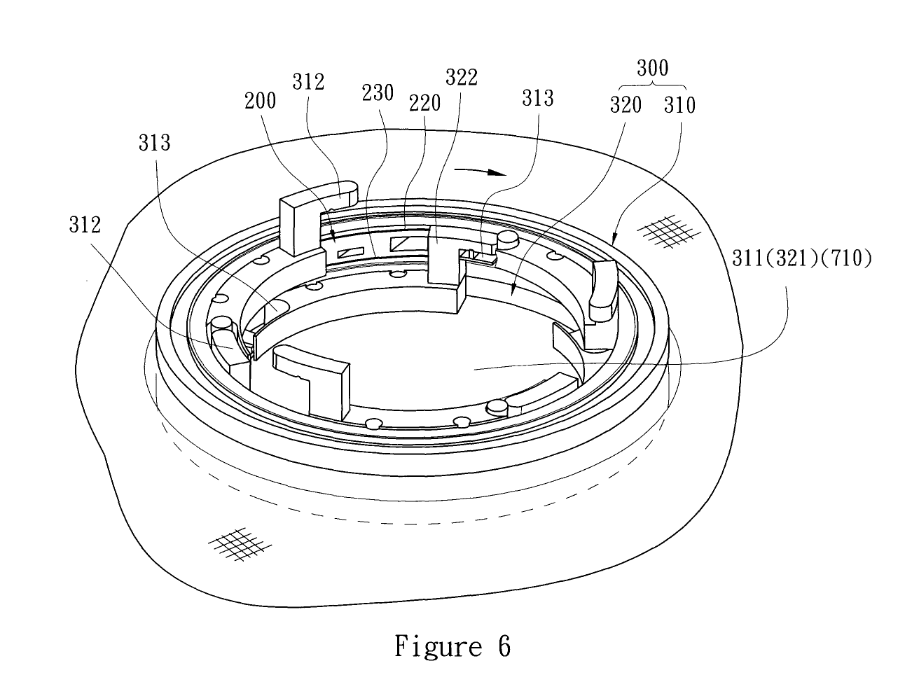

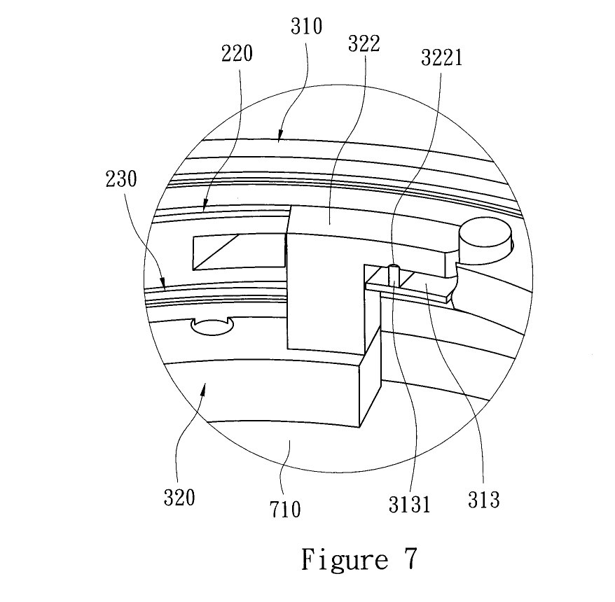

Refer to FIG. 4, FIG. 6 and FIG. 7. In each buckle unit 300, the embedded fingers 322 of the lower conducting disc 320 are set through the aperture 710 and are adjacent to the first membrane 220, and the lock portions 323 of the lower conducting disc 320 are adjacent to the second membrane 230. Rotating the embedded fingers 322 of the lower conducting disc 320 to be fixed within the lock portions 313 of the upper conducting disc 310 to provide a firm orientation which keeps the water-tightness of the reverse osmosis filtering members 200, and rotating the embedded fingers 322 of the lower conducting disc 320 disengaging from the lock portions 313 of the upper conducting disc 310 to provide a looser orientation. In addition, each embedded finger 322 has a cavity 3221, and each lock portion 313 has a flange 3131 whereby the flange 3131 is held within the cavity 3221 to position each buckle unit 300 firmly.

Refer to FIG. 2 and FIG. 4. The sealing members 400 are respectively located in the grooves 315 and 325 of the conducting disc 310 and 320, and attached to the first inner circle 222 of the first membrane 220 and the second inner circle 232 of the second membrane 230. In this embodiment, the sealing member 400 is an O-ring.

Refer to FIG. 4 and FIG. 8. One of the bores 314 of each of the conducting discs 310 is aligned with another bore 314 of the adjacent conducting discs 320 to hold a pin 800 whereby the reverse osmosis filtering members 200 and the buckle units 300 are stacked with each other to form a filtering membrane system.

The first base 500 is mounted adjacent to the reverse osmosis filtering member 200 secured on one side of the reverse osmosis filtering members by a first lid 510. The first base 500 includes a pump hole 520 communicating with the aperture 710 such that the pump 530 provides a negative pressure to pump the filtered liquid out of the system through a conduit 900. Moreover, another conduit 900′ is used for air exhaust of the system. The second base 600 is mounted adjacent to the reverse osmosis filtering member 200 secured on the other side of the reverse osmosis filtering members by a second lid 610. In this embodiment, the negative pressure provided by the pump 530 is approximately 0.5 kgw/cm².

The negative pressure reverse osmosis filtering membrane system is immersed into a sewage tank 910 and supported by a frame 920 wherein the sewage tank 910 is further pumped into air to generate turbulent flow. Consequently, the sewage within the sewage tank 910 is filtered by the reverse osmosis filtering members 200, and conducted through the room 700 to the aperture 710 such that the filtered fluid is collected by the conduit 900 and directed out of the system. In addition, each of the reverse osmosis filtering member 200 is tightly coupled with the conducting disc 310 and 320 through the sealing members 400, thereby providing greater water-tightness and preventing from water leakage.

The condensed sewage is drawn by a motor 930 to re-flow in to the sewage tank 910. Under the recyclable operation, the mud and particle suspension deposited under the sewage tank 910 can be drained out of the sewage tank 910 after a long use period. Besides, the deposited metal material can also be withdrawn for reuse.

When the mud is deposited on the surface of the membrane, the user can directly purge the surface of the first membrane 220 and the second membrane 230 by flushing caused by water pressure or scraping with the rotatable vanes because the negative pressure reverse osmosis filtering membrane system of this embodiment does not have a case to cover itself. The first membrane 220 and the second membrane 230 are smooth nano-filtration membranes with less possibility of particle adhesion such that the purge effect is enhanced and the life of the membrane is therefore extended.

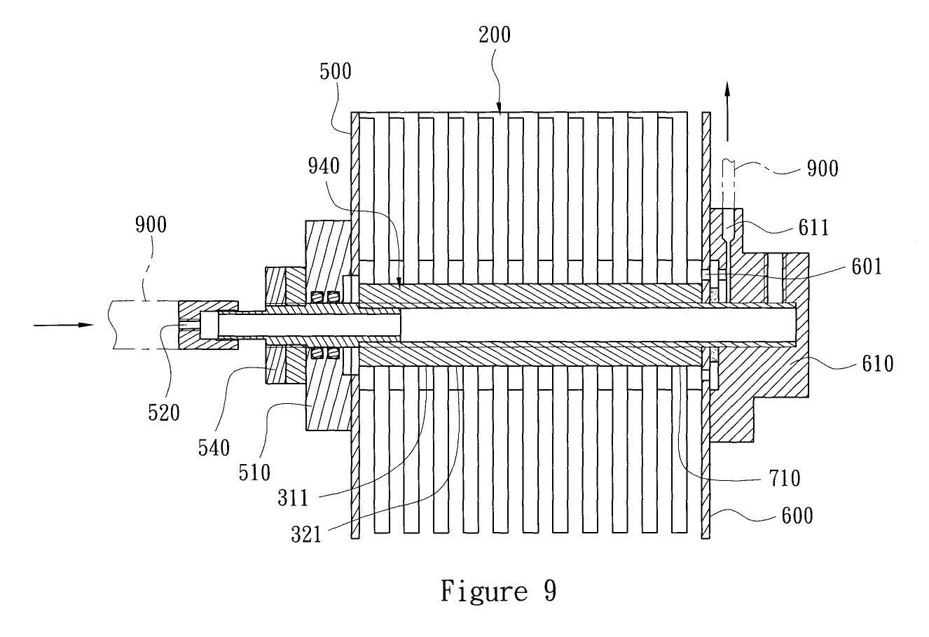

Refer to FIG. 9. The negative pressure reverse osmosis filtering membrane system applied to huge scale filtering system includes a pipe 940 set through the aperture 710, the opening 311 and the opening 321, and secured with the first base 500, the second base 600, the first lid 510, the second lid 610 and the cap 540. The pipe 940 communicates with the conduits 900 through the pump hole 520 and an exhaust hole 611. The exhaust hole 611 communicates with an exhaust hole 601 wherein the exhaust hole 601 and the exhaust hole 611 communicate with the aperture 710. The pump hole 520 is used to provide a negative pressure to pump liquid, and the exhaust hole 601 and the exhaust hole 611 are used to exhaust the air. The operation of the first embodiment and the second embodiment are the same, and there is no further description.

Compared with the conventional flat-sheet water filtering system with many problems such as water leakage, concentration polarization, deposited mud adhesion, and purge inconvenience, the negative pressure reverse osmosis filtering membrane system of the embodiment includes the following effects:

1. The negative pressure reverse osmosis filtering membrane system of the embodiment is immersed into the sewage tank 910 without any sheltering case whereby the deposit on the membranes can be directly purged by flushing or scraping. This purge method can be processed during the operation, and the entire system does not need to be shut down for cleaning purpose.

2. The reverse osmosis filtering members 200 are stacked one by another by the alternate buckle units 300, and the operation pressure of the system is low. Therefore, the filtering area of each membrane is enlarged, and water leakage problem and sewage osmosis of the reverse osmosis filtering member problems are reduced.

3. The cross flow in the sewage tank 910 provides a shear stress on the membrane surface to prevent the mud from adhering on the membrane surface. Besides, the open sewage tank 910 restrains the deposited mud on the membrane surface, decreases concentration polarization, and extends the membranes life.

4. During the filtering process, the nano-filtration membranes of the embodiment can intercept organic compounds of small molecules with negative pressure. Under the low operation pressure, the inorganic sodium can pass through the nano-filtration membranes by dialysis effect such that the nano-filtration osmosis pressure is lower than reverse osmosis pressure, and the power is reduced.

Although the present invention has been described in considerable detail with reference to certain preferred embodiments thereof, other embodiments are possible. Therefore, the spirit and scope of the appended claims should not be limited to the description of the preferred embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A negative pressure reverse osmosis filtering membrane system, comprising:
a plurality of reverse osmosis filtering members, respectively have a supporting plate, a first membrane, a second membrane and an aperture wherein the first membrane and the second membrane sandwich the supporting plate, and the aperture is defined along an axis and through the supporting plate, the first membrane and the second membrane wherein the first membrane is tightly attached on a top surface of the supporting plate, and the second membrane is tightly attached on a bottom surface whereby the supporting plate, the first membrane and the second membrane define a room communicating with the aperture for fluid osmosis;
a plurality of buckle units embedded next to each other and alternately stacked with the reverse osmosis filtering members, and each of the buckle units comprising a first conducting disc and a second conducting disc, wherein each of the first and the second conducting disc comprises an opening coaxial to the aperture, multiple embedded fingers and multiple lock portions wherein the embedded fingers are mounted through the aperture and adjacent to the first membrane, and the lock portions are adjacent to the second membrane whereby the embedded fingers of the first conducting disc are fixed within the lock portions of the second conducting disc to provide a firm orientation which keeps a water-tightness effect of the reverse osmosis filtering members, and the embedded fingers of the first conducting disc disengage from the lock portions of the second conducting disc to provide a looser orientation;
a plurality of sealing members respectively clamped between each of the buckle units and each of the reverse osmosis filtering member;
a first base mounted to the topmost reverse osmosis filtering member, and comprising a pump hole communicating with the aperture, and pumping a filtered liquid out of the reverse osmosis filtering membrane system by a negative pressure; and
a second base mounted to the bottom reverse osmosis filtering member.

2. The system of claim 1, wherein the first membrane and the second membrane are nano-filtration membranes.

3. The system of claim 1, wherein the supporting plate comprises an inner ring, an outer ring concentric to the inner ring and a net connected between the inner ring and the outer ring.

4. The system of claim 3, wherein each of the supporting plates comprises multiple protrusions protruded outward from the inner ring, and each of the conducting discs comprises multiple bores corresponding to the protrusions.

5. The system of claim 3, wherein each of the supporting plates comprises at least one block protruded outward from the outer ring.

6. The system of claim 3, wherein each of the supporting plates comprises multiple passages arranged radially on the inner ring and perpendicular to the aperture to communicate with the aperture and the room.

7. The system of claim 3, wherein the inner ring and the outer ring of the supporting plate is respectively bonded with a first inner circle and a second inner circle.

8. The system of claim 1, wherein the negative pressure is approximately 0.5 kgw/cm².

9. The system of claim 1, wherein the second base comprises an exhaust communicating with the apertures of the reverse osmosis filtering members.
